(19) United States
(12) Patent Application Publication
(10) Pub. No.: US 2009/0265366 A1
(43) Pub. Date: Oct. 22, 2009

(54) OPPORTUNISTIC OPINION SCORE COLLECTION ON A MOBILE DEVICE

(75) Inventors: Maria I. Marshall-wilson, Oceanside, CA (US); David James Fischer, San Diego, CA (US); George Joseph, San Diego, CA (US); Mark Robert Storch, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/107,667

(22) Filed: Apr. 22, 2008

(51) Int. Cl. G06F 17/30

(52) U.S. Cl. 707/100; 707/E17.005

(57) ABSTRACT

Opportunistic transmission of voting and/or opinion data can occur from a user's mobile device to a server. The user can be presented a form to complete, where the form is designed to facilitate gathering of opinion information. Opinion data gathered from the form can be opportunistically transmitted to a server, where transmission commonly occurs when a supplemental transmission takes place. The transmission can be received by a server and a user that provided the opinion and/or voting information can be rewarded, such as through a monetary payment. The opinion and/or voting information can be extracted and retained in storage.

### BACKGROUND

I. Field

The following description relates generally to wireless communications, and more particularly to collecting and opportunistically transmitting user input data in a wireless communication system.

II. Background

Wireless communication systems are widely deployed to provide various types of communication; for instance, voice and/or data can be provided via such wireless communication systems. A typical wireless communication system, or network, can provide multiple users access to one or more shared resources. For instance, a system can use a variety of multiple access techniques such as Frequency Division Multiplexing (FDM), Time Division Multiplexing (TDM), Code Division Multiplexing (CDM), and others.

Common wireless communication systems employ one or more base stations that provide a coverage area. A typical base station can transmit multiple data streams for broadcast, multicast and/or unicast services, wherein a data stream can be a stream of data that can be of independent reception interest to a user device. A user device within the coverage area of such base station can be employed to receive one, more than one, or all the data streams carried by the composite stream. Likewise, a user device can transmit data to the base station or another user device.

Typical wireless communication systems oftentimes are leveraged to obtain opinions (e.g., ratings, votes, preferences, and the like) from users. For example, conventional data collection techniques can utilize a wireless communication system to verbally conduct surveys of users; according to this example, a parry collecting data can call user devices to obtain and collect responses from users. Further, voting can be performed by designating several phone numbers, one of which the voter uses to vote by calling that number. The call can then be registered as a vote for or against the “value” assigned to that phone number. Alternatively, user devices can be utilized to communicate with Internet sites where votes can be collected as users visit the site and designate their vote, preference, opinion, and so forth. However, common data collection techniques can be time consuming, inefficient, disruptive and/or can employ significant over-the-air resources of wireless communication systems.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a method that facilitates collection of opinion information is disclosed herein. The method can comprise obtaining operator opinion information through utilization of a mobile device application. The obtainment of opinion information is commonly facilitated through use of a form. The method can also comprise transmitting the opinion information to an auxiliary location at an opportunistic time.

Another aspect relates to a wireless communication apparatus that comprises a data collector that obtains operator opinion information, obtainment of opinion information is facilitated through use of a form is disclosed herein. Additionally, the apparatus can include a data transmitter that emits the obtained operator opinion information to an auxiliary location at an opportunistic time.

Yet another aspect relates to a wireless communications apparatus that facilitates opinion information collection. The apparatus can include means for obtaining operator opinion information through utilization of a mobile device application. Obtainment of opinion information can be facilitated through use of a form. Moreover, the apparatus can include means for transmitting the opinion information to an auxiliary location at an opportunistic time.

Still another aspect relates to a machine-readable medium having stored thereon machine-executable instructions for obtaining operator opinion information through utilization of a mobile device application, obtainment of opinion information is facilitated through use of a form. There can also be instructions for transmitting the opinion information to an auxiliary location at an opportunistic time upon the machine-readable medium.

A further aspect relates to an apparatus in a wireless communication system that includes a processor configured to obtain operator opinion information through utilization of a mobile device application, obtainment of opinion information is facilitated through use of a form. Additionally, the processor can configure to transmit the opinion information to an auxiliary location at an opportunistic time.

According to an aspect, a method that facilitates collection of opinion information is disclosed herein. The method comprises receiving a data transmission with opinion information from a mobile device at an opportunistic time. In addition, the method can comprise rewarding an entity that provided the opinion information based upon successful receipt of the opinion information.

In another aspect, there can be a wireless communication apparatus, comprising a memory that retains instructions related to reception of a data transmission with opinion information from a mobile device at an opportunistic time and providing a reward to an entity that provided the opinion information based upon successful receipt of the opinion information. Moreover, there can be a processor coupled to the memory, configured to execute the instructions retained in the memory.

A further aspect relates to a wireless communications apparatus that facilitates opinion information collection. The apparatus can comprise means for receiving a data transmission with opinion information from a mobile device at an opportunistic time. The apparatus can also comprise means for rewarding an entity that provided the opinion information based upon successful receipt of the opinion information.

Still another aspect relates to a machine-readable medium having stored thereon machine-executable instructions for receiving a data transmission with opinion information from a mobile device at an opportunistic time. In addition, there can be instructions for rewarding an entity that provided the opinion information based upon successful receipt of the opinion information.

In yet another aspect, in a wireless communication system, an apparatus is disclosed comprising a processor configured to receive a data transmission with opinion information from a mobile device at an opportunistic time. The processor can also be configured to reward an entity that provided the opinion information based upon successful receipt of the opinion information.

To accomplish at least the aforementioned aspects, the subject specification discloses one or more embodiments that can be used to accomplish the aspects, where the aspects can be fully described and particularly pointed out in the claims. The following description and the annexed drawings set forth in detail certain illustrative aspects of the one or more embodiments. These aspects are indicative, however, of but a few of the various ways in which the principles of various embodiments can be employed, and the described embodiments are intended to include all such aspects and their equivalents.

### BRIEF DESCRIPTION OF THE DRAWINGS

FIG. 1 is an illustration of an example wireless communication system in accordance with various aspects set forth herein.

FIG. 2 is an illustration of an example mobile device and server configuration for data collection and opportunistic data transmission.

FIG. 3 is an illustration of an example detailed mobile device and server configuration for data collection and opportunistic data transmission.

FIG. 4 is an illustration of an example mobile device and detailed server configuration for data collection and opportunistic data transmission.

FIG. 5 is an illustration of an example mobile device and base station integrated with a server configuration for data collection and opportunistic data transmission.

FIG. 6 is an illustration of an example methodology that facilitates data collection and transmission.

FIG. 7 is an illustration of an example methodology that facilitates actions of a mobile device during data collection and opportunistic data transmission.

FIG. 8 is an illustration of an example methodology that facilitates actions of a base station concerning data collection and opportunistic data transmission.

FIG. 9 is an illustration of an example mobile device that facilitates data collection and opportunistic data transmission.

FIG. 10 is an illustration of an example server that facilitates data collection and opportunistic data transmission.

FIG. 11 is an illustration of a wireless network environment that can be employed in conjunction with the various systems and methods described herein.

FIG. 12 is an illustration of an example system that communicates collected data.

### DETAILED DESCRIPTION

Various embodiments are now described with reference to the drawings, wherein like reference numerals arc used to refer to like elements throughout. In the following description, for purposes of explanation, numerous specific details are set forth in order to provide a thorough understanding of one or more embodiments. It can be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution, and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and or carrying instruction(s) and/or data.

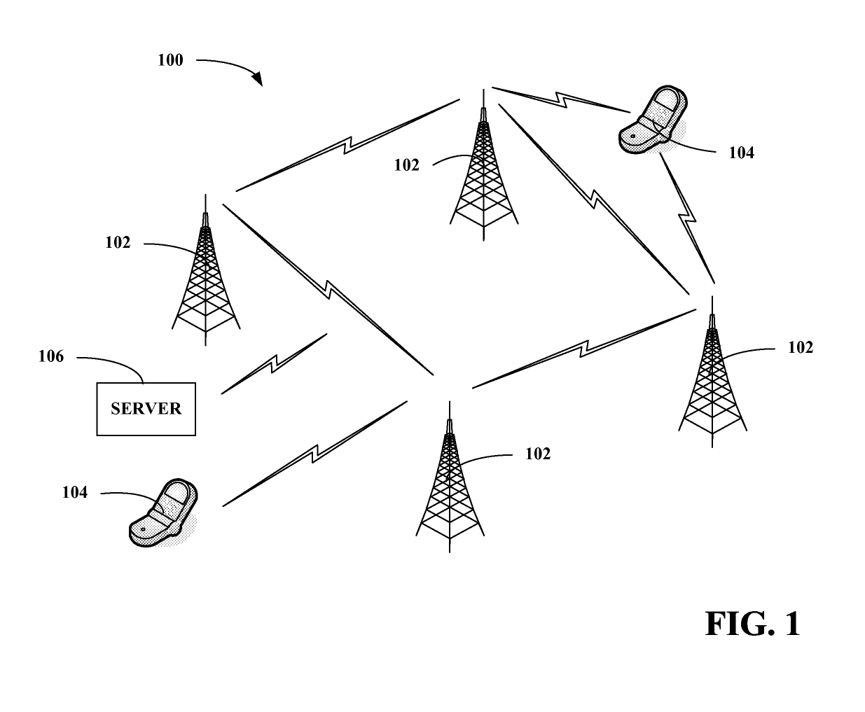

Referring now to FIG. 1, a wireless communication system 100 is illustrated in accordance with various embodiments presented herein. System 100 can comprise one or more base stations 102 (e.g. access points) in one or more sectors that receive, transmit, repeat, etc., wireless communication signals to each other and/or to one or more mobile devices 104. Each base station 102 can comprise a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art. Mobile devices 104 can be, for example, cellular phones, smart phones, laptops, handheld communication devices, handheld computing devices, satellite radios, global positioning systems, PDAs, and/or any other suitable device for communicating over the wireless communication system 100.

Each mobile device 104 can communicate with one or multiple base stations 102 on a forward link and/or reverse link at any given moment. The forward link refers to a communication link from base stations 102 to mobile devices 104, and the reverse link refers to a communication link from mobile devices 104 to base stations 102. Base stations 102 can further communicate with a server 106 (e.g., the server can be in a base station 102, a third party device accessable through the base station 102, and so forth); thus, for example, base stations 102 can obtain user input data from mobile devices 104 (as described herein) and thereafter provide the user input data to the server. It is contemplated that any number of servers can be utilized to collect user input data. Further, it is to be appreciated that one or more base stations 102 can include server(s) and/or the server(s) can be separate from base stations 102.

Wireless communication system 100 can opportunistically collect user input data. For example, mobile devices 104 can be employed by users to enter user input data. The user input data can be related to an opinion, a rating, a preference, a vote (e.g., for, against, . . . ), a lack of a vote, a score, a consensus, and the like. Further, an application resident upon mobile devices 104 can obtain the input data from users. The user input data can be retained by mobile devices 104 for later retrieval and/or forwarded to a server for collection in a database. Thus, wireless communication system 100 can mitigate utilization of over-the-air resources for submitting user input data. Further, wireless communication system 100 needs not employ dedicated phone numbers for selecting a particular user input (e.g., voting for a particular value by dialing a first number to vote for x and another number to vote for y). Rather, user input data stored on mobile devices 104 can be downloaded to a server for collection when each of the mobile devices 104 is utilizing the over-the-air link for any disparate reasons; thus, an opportunistic download of user input data can be effectuated for communicating user input data from mobile devices 104 to base stations 102.

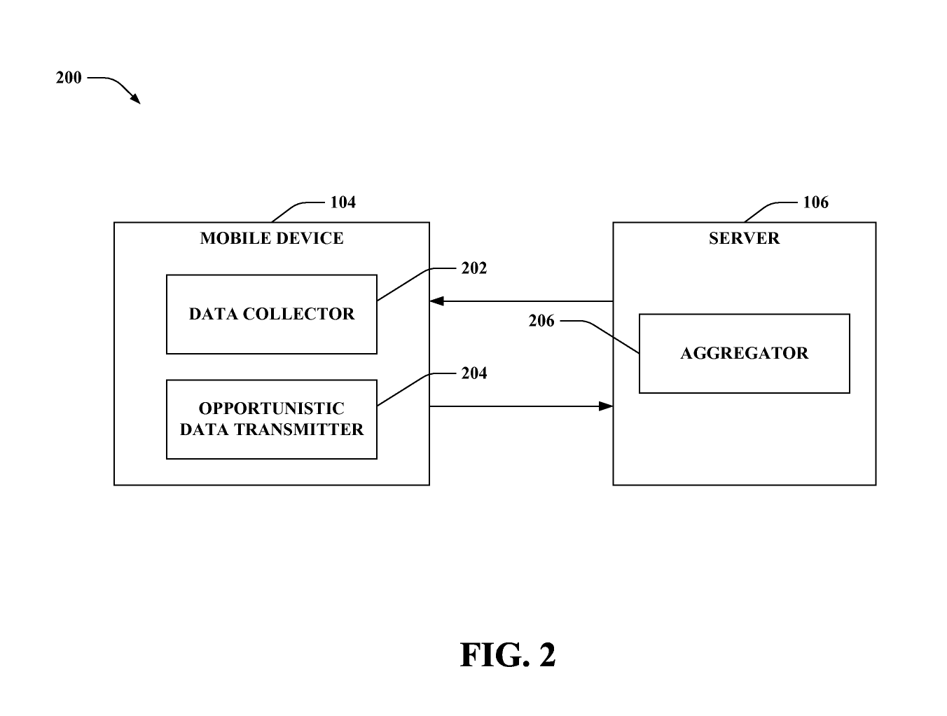

With reference to FIG. 2, illustrated is an example system 200 that collects and selectively transmits user input data in a wireless communication environment, commonly user input data that relates to an opinion on a matter. System 200 includes a mobile device 104 that communicates with a server 106. Further, it is to be appreciated that various other of mobile devices similar to mobile device 104 can communicate with any number of servers similar to server 106. Moreover, although not depicted, it is contemplated that mobile device 104 can communicate with a base station, and the base station can communicate with server 106; thus, opportunistic transmission utilizing over-the-air resources can be effectuated between mobile device 104 and the base station.

A data collector 202 of the mobile device 104 can enable obtaining of user input data from operator(s) of mobile device 104, specifically opinion information, through use of an application, oftentimes, obtainment of opinion information is facilitated through a form (e.g., a questionnaire that a user completes where questions are directed at obtaining user opinion). For example, data collector 202 can generate a user interface that can be leveraged to interact with a user. Additionally or alternatively, data collector 202 can produce an output (e.g., audible, visual, physical movement, . . . ) to the user, and collect any type of user input. By way of illustration, data collector 202 can yield an entry form upon a display associated with mobile device 104, and the form can be filled by a user of mobile device 104 such that responses can be retained by data collector 202 through internal memory. It is contemplated that data collector 202 can obtain forms, surveys, questions, polls, and the like from one or more sources, and thereafter provide such information to users to obtain corresponding user input data.

An opportunistic data transmitter 204 can enable selectively transmitting user input data retained by data collector 202. For example, opportunistic data transmitter 204 can transfer user input data wirelessly (e.g. to server 106) when mobile device 104 utilizes over-the-air resources for transmitting disparate data. According to one example, the opportunistic data transmitter 204 can enable retaining the user input data (e.g., in memory of mobile device 104) when mobile device 104 is not transmitting disparate data via the over-the-air link. Additionally or alternatively, the opportunistic data transmitter 204 can transmit user input data obtained via employing data collector 202 in response to a request obtained from server 106 (and/or a base station (not shown)).

In an illustrative instance, a mobile device 104 can receive a form asking five questions relating to a new product. The form can be presented to an operator through a user interface with different engagement icons. The user can quickly answer the questions and engage a send icon. However, the opportunistic data transmitter 204 can use internal logic to determine that the mobile device 104 is not engaged in an over-the-error transmission. The opportunistic data transmitter 204 holds the completed form in storage and attempts to detect an over-the error transmission. When the operator makes a phone call with the mobile device 104, the opportunistic data transmitter 204 can emit the completed form to the server 106. Therefore, mobile device resources are not wasted (e.g., the device is in a sending state once as opposed to twice, where the sending state consumes a relatively large amount of battery power.)

Moreover, server 106 can include an aggregator 206 that obtains user input data collected with data collector 202 from mobile device 104 (and/or a number of disparate mobile devices similar to mobile device 104). Aggregator 206 can request the user input data from mobile device 104; thus, a signal can be transferred from server 106 to mobile device 104, and user input data can be received from mobile device 104 in response. According to another example, aggregator 206 can obtain user input data when mobile device 104 utilizes the over-the-air link for communicating data other than user input data; therefore, aggregator 206 need not provide a request for the user input data retained by data collector 202 (and/or mobile device 104).

In an illustrative example for operation of the system 200, a popular television show can have a number of different contestants perform musical numbers. Viewers can use the mobile device 104 to send in their votes to a server 106. The data collector 202 discloses a user interface through a display of the mobile device 104 that includes a graphical portion that can be engaged to receive a vote. A viewer can engage a particular interface section that relates to a contestant for whom he/she would like to vote. The data collector 202 can retain a selection choice in local memory until the vote is ultimately transmitted. The opportunistic data transmitter 204 can initially communicate with the server 106 to determine if voting is open. When voting becomes open, if voting is already open, etc., the opportunistic data transmitter 204 can send the vote to the server 106, where the aggregator 206 obtains the vote. The aggregator 206 can perform operations upon collected data, such as adding votes received from a plurality of mobile devices, similar to mobile device 104.

The subject specification and related claims teach away from market trends and conventional industry beliefs. Classically, users vote by calling a particular number the relates to an opinion. For example, for contestant A call (555) 555-5555, while for contestant B call (555) 555-5556. Industry improvements focus on improving calling structures, such as minimizing a likelihood that communication lines will become clogged with numbers (e.g., producing a busy signal that does not allow a person to vote). Since problems occur from heavy traffic, it is illogical to operate one construct to convey different votes—it appears there should be more communication lines, not less. However, disclosed information produces the unexpected result of improved communication since information can be opportunistically transmitted and obtained through a local application upon the mobile device 104.

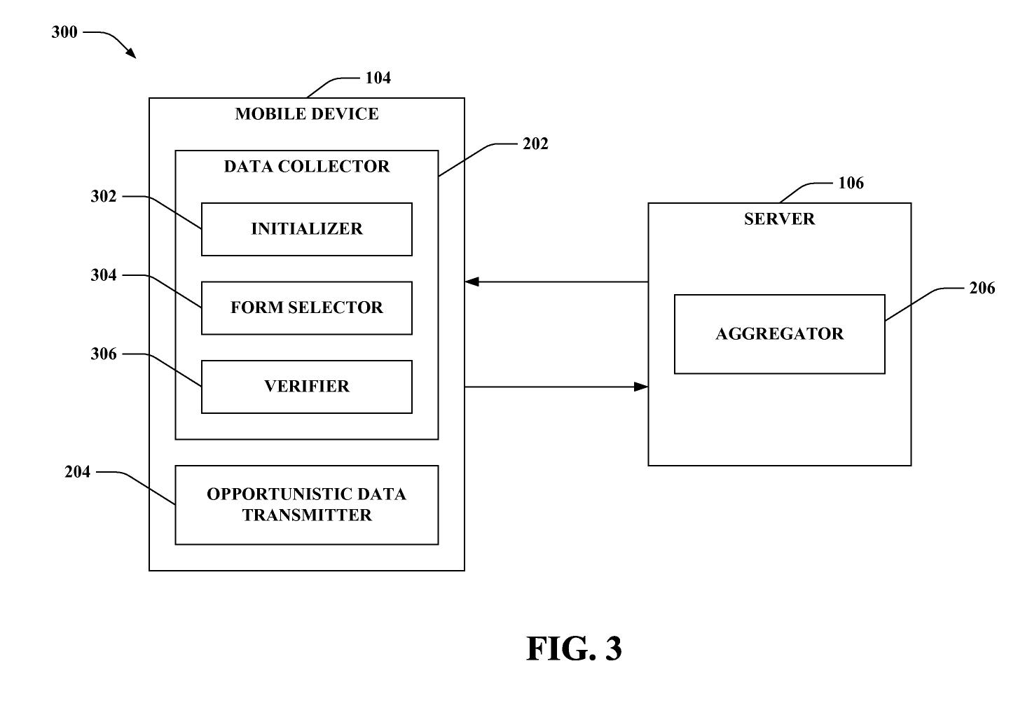

Now referring to FIG. 3, illustrated is an example system 300 that facilitates collecting user input data in a wireless communication environment. System 300 includes mobile device 104 that communicates with server 106. Mobile device 104 can utilize data collector 202 to assemble user input data; the user input data can be retained (e.g., in memory) by mobile device 104 and/or transmitted to server 106 by employing an opportunistic data transmitter 204. Further, server 106 can include aggregator 206 to collect and/or store user input data obtained from mobile device 104 (and/or a number of disparate mobile devices).

Data collector 202 of mobile device 104 can include an initializer 302 that can configure to begin a process of data collection. Often times, data collection is to take place with regard to a specific context. For example, a poll to determine if a candidate should run for an office does not take place after an election. The initializer 202 can determine when the data collector 202 should begin an operation (e.g., obtaining information for an event). In many instances, the initializer 302 is in direct communication with the server 106 and the server 106 sends instructions to initializer 302 to begin data collection.

A form selector 304 chooses a specific form in which to present to a user in order to collect data. For example, the server 106 can instruct the data collector 202 to collect information about a user's experience using the mobile device 104. However, when making the instruction, the server 106 likely does not know the language the user is most comfortable using. Therefore, the form selector 304 can make a request to a user to input information as to the language in which he/she would like to communicate. The form selector 304 chooses an appropriate form based on provided information. It is to be appreciated that the form selector 304 can operating automatically without requiring information from the user or any external source. The form selector 304 can configure to use internal parameters in making a selection.

A verifier 306 can perform checks on operation of the data collector 202, the mobile device 104, and/or other units of the mobile device 104. The verifier 306 can determine if a request send by a server 106 is acceptable. For example, the data collector 202 can configure to collect only data about a user's experience using the mobile device 104. However, die server 106 can send a request about the user's financial information. Since a financial request is not within the configuration of the data collector 202, the verifier 306 can reject the request. In another embodiment, the verifier 306 checks validity of collected information. For example, a user can enter data as to their present location. A verifier 306 can engage global positioning technology to determine if the user provided a correct answer.

In another embodiment, the verifier 306 can perform a check that the initializer 302 is beginning the correct data collection. For example, a server 106 can request data collection about a user's power consumption using while using the mobile device 104. However, the initializer 302 mistakenly sends a command to gather data about a user's response to television programming selection. In this example, the verifier 306 can identify an initializer 302 error and attempt to make a correction. In a further embodiment, the initializer 302 can perform a similar check on a form chosen by the form selector 304. In another embodiment, the verifier 306 can perform a check on structures outside the data collector 202. For example, the verifier 306 can check if a request from an opportunistic data transmitter 204 is valid, wherein the opportunistic data transmitter 204 sends a message to the server 106 to determine if it is an opportunistic time. It is to be appreciated that the verifier 306 can perform checks for validation as well as configure to attempt to correct errors from instances where there is not proper verification.

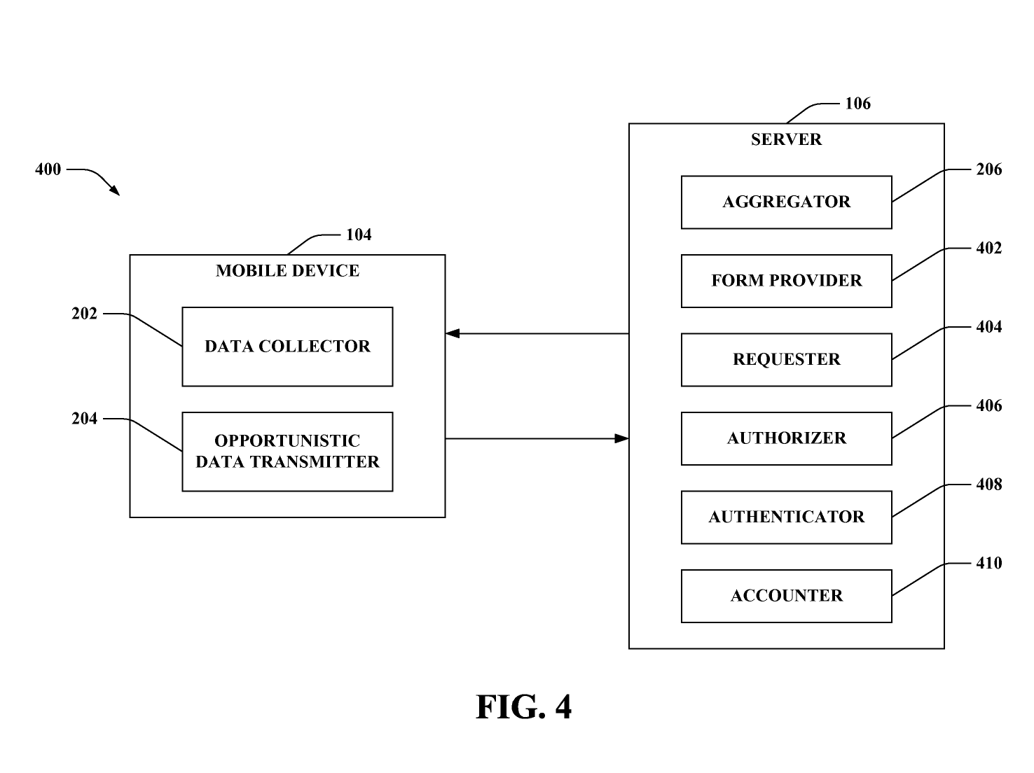

Now referring to FIG. 4, illustrated is an example system 400 that facilitates sending a request to collect user input data in a wireless communication environment. System 400 includes mobile device 104 that communicates with server 106. Mobile device 104 can utilize the data collector 202 to assemble user input data. The user input data can be retained by mobile device 104 (e.g., in memory) and/or transmitted to server 106 by employing opportunistic data transmitter 204. Further, server 106 can include aggregator 206 to collect and/or store user input data obtained from mobile device 104 (and/or any number of disparate mobile devices).

A server 106 can desire to provide a specific form for data collection through a form provider 402. For example, there can be very intricate questions created for a specific application (e.g., questions relating to possible votes in an election). It can be necessary'to provide a specific form to a user so there is no undue influence on their selection. Therefore, the form provider 402 can send a specific form in which to present to a user for data collection. The form provider 402 can configure to override a form selector similar to the form selector 304 in FIG. 3. In another embodiment, a form distributed by the form provider 402 can be used when there is no appropriate form available for selection by a form selector similar to the form selector 304 in FIG. 3. Moreover, internal logic can be used (e.g., practicing of artificial intelligence techniques) to make a determination of a form to use when conflicting forms are provided.

A requester 404 can make an appeal to an auxiliary device to send information pertaining to data that should be collected and/or has been collected. In one embodiment, the requestor 404 sends an appeal to the mobile device 104 to collect data from a user. However, the requestor 404 can send a command to the mobile device 104 to send information it has recently collected. Moreover, the requestor 404 can make a request to the mobile device 104 asking a user if they would volunteer for data collection. In a further example, the requestor 404 sends an application to the opportunistic data transmitter 204 to send data immediately even if a current time is not designated as an opportunistic time.

Authorizer 406 checks on overall permission of a request for collecting data. For example, an administrator can want to collect data from mobile devices 104 as part of a focus group for a new product. The authorizer 406 checks if the administrator has permission to make this request. In another embodiment, the authorizer 406 can make sure the aggregator 206 is allowed to make a specific request for data. It is to be appreciated the authorizer can configure upon the mobile device 104 in addition to the server 106.

Authenticator 408 determines if information is valid and/or can be further processed. When data enters the server 106 from the mobile device 104, the authenticator 408 can perform a check to determine what mobile device 104 sent the information. Further, the authenticator 408 can check if the mobile device 104 that sent information is known to the server 106 or to an overall network. In an illustrative example, the authenticator 408 can check validity of data sent from a mobile unit. In a different configuration, the authenticator 408 check a communication sent from a base station. It is to be appreciated that the authenticator 408 can have denial power, meaning it cannot allow information to enter and/or exit the server 106 unless it can be properly authenticated. Aspects of the authenticator can be practiced by the verifier 306.

Accounter 410 makes appropriate financial calculations in relation to opportunistic data collection. The accounter 410 can reward an entity (e.g., a user) that provided the opinion information based upon successful receipt (e.g., the opinion information is received and completed properly according to a standard) of the opinion information and successful receipt can result in financial charges to an account associated with the mobile device 104. For example, the opportunistic data collector 202 can be debited when a user sends a form that relates to a contestant he/she wants to win a television contest. In another embodiment, the accounter 410 can be configured to compute fiscal information regarding the server 106. In an illustrative implementation, if the server sends a specific form upon which data is to be collected, then a fee can be paid to a form supplier. The accounter 410 can be implemented as part of the mobile device 104.

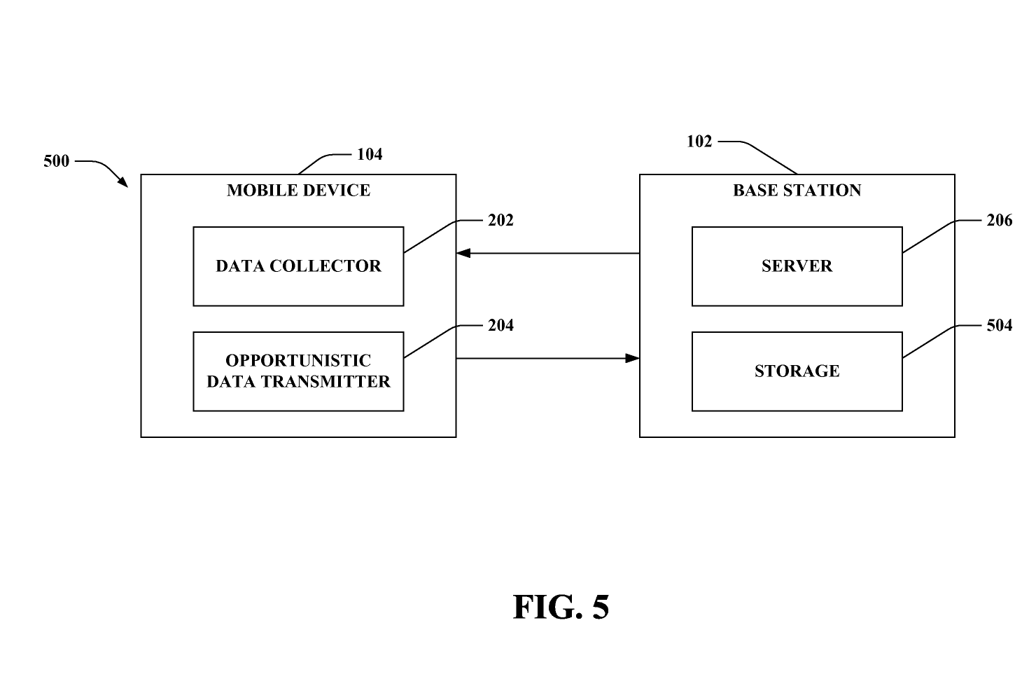

With reference to FIG. 5, illustrated is an example system 500 that collects and selectively transmits user input data in a wireless communication environment. Disclosed features are similar lo the features shown in FIG. 2. There is a mobile device 104 with a data collector 202 and an opportunistic data transmitter 204. The mobile device 104 communicates with a base station 502. The base station 502 can include a server 106; however, it is to be appreciated that the server 106 can be a separate entity from the base station 502 and the base station 502 transfers information from the mobile device 104 to the server 106. Storage 504 can be used to hold data that was transmitted opportunistically. While the storage 504 is disclosed as being held upon the base station, the storage can also be located remotely or held upon the mobile device 104. Example storage configurations include flash memory, hard disk, battery backed memory, magnetic disk, etc.

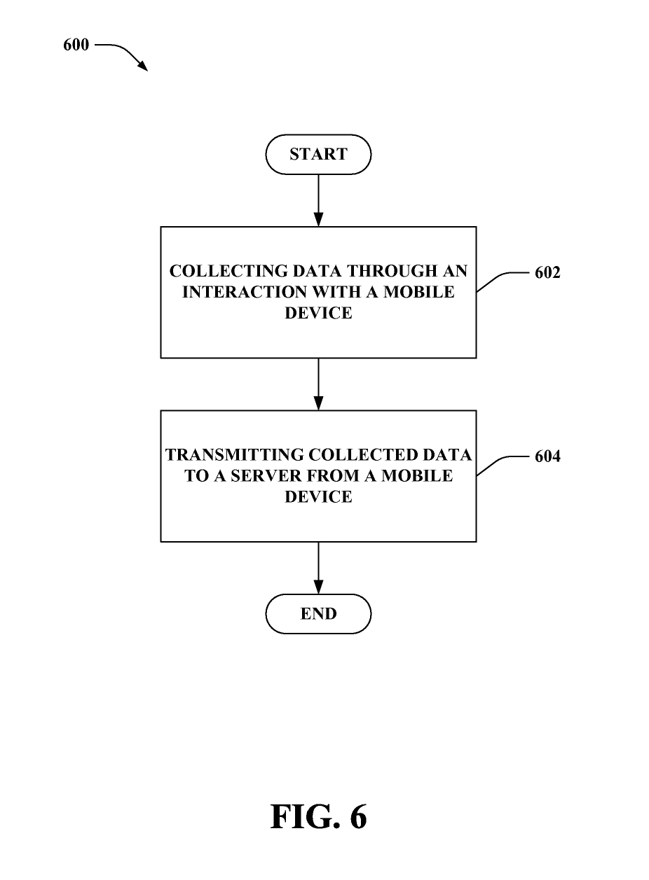

Referring to FIGS. 6-8, methodologies relating to data collection based on interactions with a mobile device, such as the mobile device 104 of FIG. 1. For example, methodologies can relate to data collection with such devices in an FDMA environment, an OFDMA environment, a CDMA environment, a WCDMA environment, a TDMA environment, an SDMA environment, or any other suitable wireless environment. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

Now turning to FIG. 6, illustrated is an example methodology 600 that facilitates collecting and processing data about a transaction on a mobile device, such as the mobile device 104 of FIG. 1. The methodology 600 discloses obtaining information (e.g., opinion information) of an operator through utilization of a mobile device application and transmitting the information to an auxiliary location (e.g., opportunistic transmission).

Event 602 is collecting data through an interaction with a mobile device, such as the mobile device 104 of FIG. 1. This can operate as obtaining opinion information of an operator through utilization of a mobile device application. According to one embodiment, an application is run upon the mobile device, such as the mobile device 104 of FIG. 1, such as a word processing application. The word processing application presents a questionnaire to an operator of the mobile device, such as the mobile device 104 of FIG. 1. The user can engage the application with a stylus and complete the questionnaire.

Event 604 is transmitting collected data to the server 106 from the mobile device, such as the mobile device 104 of FIG. 1. After collection, information can either be retained on local storage or immediately transmitted to an auxiliary location (e.g., the server). Commonly, transmission takes place wirelessly at an opportunistic time. For instance, the transmission occurs when an operator is using the mobile device, such as the mobile device 104 of FIG. 1 for another purpose, such as making a telephone call. However, there can be other opportunistic situations aside from when the mobile device, such as the mobile device 104 of FIG. 1 is engaged in another activity. In an illustrative example, a user can have a mobile device plan where they are not charged for communications between 7 pm to 7 am. Event 604 can determine a time to send the collected information so an owner of the mobile device, such as the mobile device 104 of FIG. 1 is not charged for the transaction.

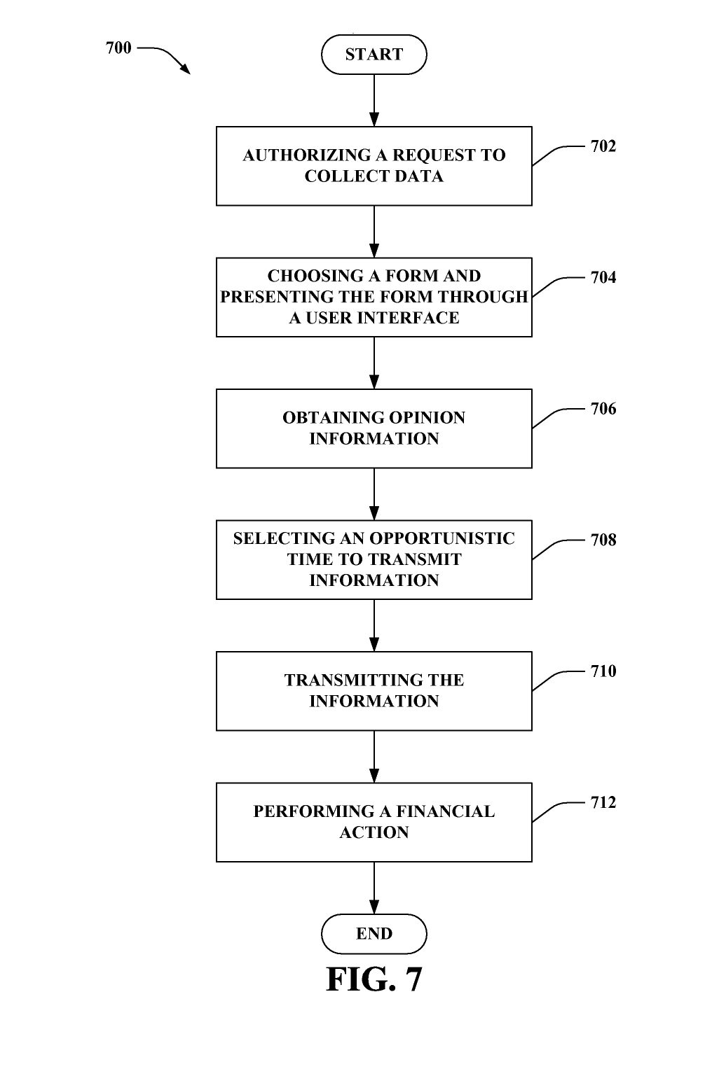

Now turning to FIG. 7, illustrated is an example methodology 700 that facilitates processing for data collection in regards to a server. It is to be appreciated that while one embodiment discloses the methodology 700 in regards to a server, the disclosed information can be practiced in on other devices and each action can take place on a separate device.

Event 702 is authorizing a request to collect data. A mobile device, such as the mobile device 104 of FIG. 1 can receive a large number of requests for information (e.g. through messages commonly referred to as ‘spam’). Event 702 enables intelligent selection of request, where appropriate requests are allows and other requests are denied. For instance, if the user owns a particular automobile, a survey on quality of the manufacturer can be allowed while requests to sell the car can be denied (e.g., considered unauthorized). This allows for authenticating a request to obtain opinion information, where obtaining opinion information takes place when a request is authenticated.

Event 704 is choosing a form and presenting the form through a user interface. Commonly a number of different forms can be used to gain information. Forms can range from specifically created configurations to general templates; internal logic can be used to select a form. Once an appropriate form is selected, it can be presented to the user through an application (e.g., word processing application) disclosed via a user interface.

Event 706 is obtaining opinion information; commonly by receiving information entered by a user. For example, a form is presented to a user with selection choices ‘yes’ and ‘no’. When a user presses a stylus against a choice, event 706 processes the user action to determine it indicates the user is selecting the choice and the choice can be saved in local storage.

Event 708 is selecting an opportunistic time to transmit information. To save mobile device resources, information can be transmitted at an opportunistic time (e.g., when another transmission takes place, a transmission a common location, when it will have a low cost, etc.). Artificial intelligence techniques (e.g., modeling, adaptive learning, etc.) can be employed to anticipate when an opportunistic time will take place as well as quality of an opportunistic time (e.g., now is a good time, but a better time is anticipated in the future).

Event 710 is transmitting the information; commonly transmission takes place between a mobile device, such as the mobile device 104 of FIG. 1 operating the methodology 700 and a base station. The transmission can take place over several portions. For instance, if information is not completely sent over one communication, then information transfer can stop and resume in a subsequent communication takes place.

Event 712 is performing a financial action: collection of information can relate to various types of financial actions. In illustrative instances, a user can be paid money to provide opinion information and the user can be charged an amount to transfer the information to a base station. Financial actions can include performing monetary manipulation (e.g. crediting/debiting an account), performing a calculation on money to be transferred, etc.

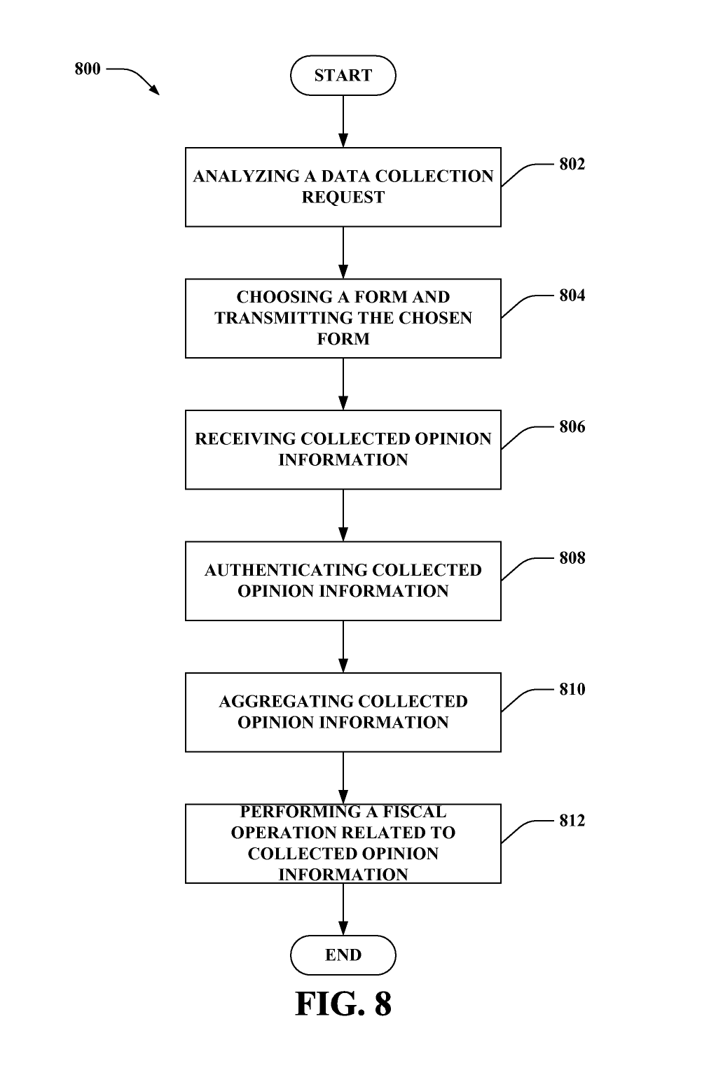

Now turning to FIG. 8, illustrated is an example methodology 800 that facilitates processing for data collection in regards to a mobile device, such as the mobile device 104 of FIG. 1. It is to be appreciated that FIG. 7 and FIG. 8 can work in conjunction with one another and various actions can be practiced by a base station, such as the base station 102 of FIG. 1 and/or mobile device, such as the mobile device 104 of FIG. 1 (e.g. storing collected information).

Event 802 is analyzing a data collection request. A third party can make a request to collect data from at least one mobile device, such as the mobile device 104 of FIG. 1. For instance, a request can be made that users of a particular mobile device, such as the mobile device 104 of FIG. 1 be asked there preferences on mobile device functionality. Event 802 allows for determining if a party inquiring about an opinion has authority to request a data transmission and then requesting that the mobile device, such as the mobile device 104 of FIG. 1 send a data transmission with opinion information based upon a determination that the party has authority to request a data transmission.

Event 804 is choosing a form and transmitting the chosen form. In order to collect desired pieces of information, as specific form can be used that facilitates gathering desired information. For example, a request that a user provide information concerning qualities of a product, specific questions can gathered improved results. An interactive form can provide quality answers (e.g., depending on answers to a previous questions, different supplemental questions are provided.) The form is transferred to a mobile device, such as the mobile device 104 of FIG. 1, commonly though a wireless manner.

Event 806 is receiving collected opinion information. A mobile device, such as the mobile device 104 of FIG. 1 can transfer information (e.g., the form transmitted in act 804, a modified version of the form transmitted in act 804, a different form, raw data, etc.) to a base station/server operating the methodology 800. Reception can include saving obtained information upon local and/or remote storage.

Event 808 is authenticating collected information. Collected information can be checked to ensure that it came from a proper device (e.g., a reputable device, an intended device, etc.) Since data can be sensitive and/or important, it can be beneficial to determine a device from which the data originates. Event 808 determines if the device was proper as well as if information is consistent (e.g., if there are conflicting answers, then data can be removed.)

Event 810 is aggregating collected opinion information. Collected data can be combined with other data to create a usable set. Algorithms can be used to combine similar data; data that reflects positive answers (e.g. ‘yes’ answers) can be identified and listed as a ‘yes’. Aggregated data can be transferred to a requesting party or held in storage.

Event 812 is performing a fiscal operation related to collected opinion information. Commonly, in order to operate the methodology 800, an operating company is paid a price. The price can be paid by the requestor, a third party, etc. Fiscal operations can include performing monetary manipulation (e.g., crediting/debiting an account), performing a calculation on money to be transferred, etc.

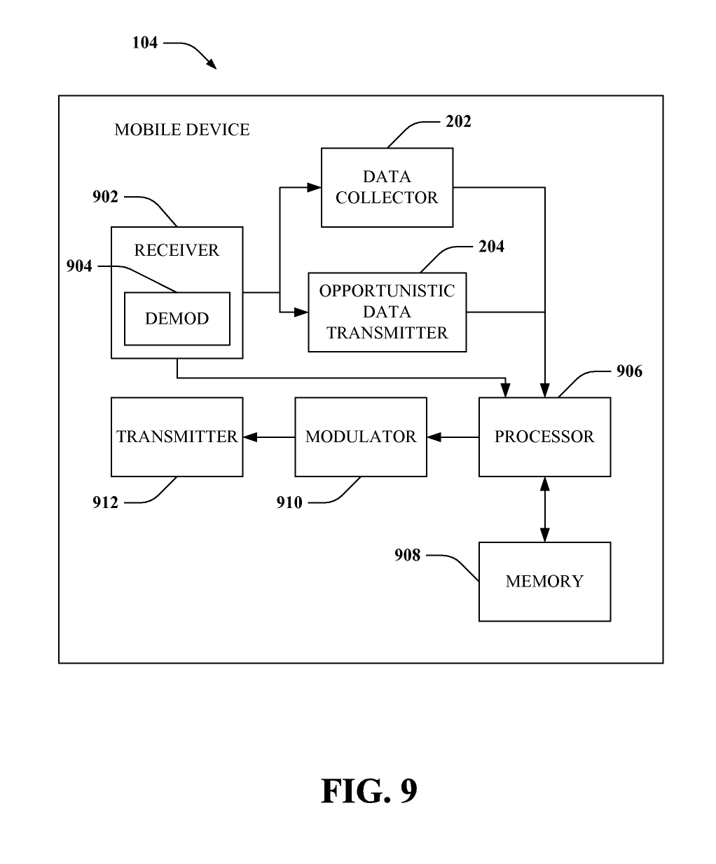

FIG. 9 is an illustration of a mobile device 104 (e.g. cellular telephone) that facilitates collection and opportunistic transmission of data. Mobile device 104 comprises a receiver 902 that receives a signal from, for instance, a receive antenna (not shown), and performs typical actions thereon (e.g. filters, amplifies, downconverts, etc.) the received signal and digitizes the conditioned signal to obtain samples. Receiver 902 can be, for example, an MMSE receiver, and can comprise a demodulator (DEMOD) 904 that can demodulate received symbols and provide them to a processor 906 for channel estimation. Processor 906 can be a processor dedicated to analyzing information received by receiver 902 and/or generating information for transmission by a transmitter 912, a processor that controls one or more components of mobile device 104, and/or a processor that both analyzes information received by receiver 902, generates information for transmission by transmitter 912, and controls one or more components of mobile device 104.

Mobile device 104 can additionally comprise memory 908 that is operatively coupled to processor 906 and that can store data to be transmitted, received data, information related to available channels, data associated with analyzed signal and/or interference strength, information related to an assigned channel, power, rate, or the like, and any other suitable information for estimating a channel and communicating via the channel. Memory 908 can additionally store protocols and/or algorithms associated with estimating and/or utilizing a channel (e.g. performance based, capacity based, etc.).

It will be appreciated that the data store (e.g., memory 908) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM). Synchlink DRAM (SLDRAM), and direct Rambus RAM (DRRAM). The memory 908 of the subject systems and methods is intended to comprise, without being limited to, these and any other suitable types of memory.

Receiver 902 is further operatively coupled to a data collector 202 that alters operation of mobile device 104 in response to received information. For instance, receiver 902 can obtain a command to collect information and the command can be transferred to a data collector 202. In response to the received information, data collector 202 can alter any operating parameter associated with mobile device 104. By way of illustration and not limitation, data collector 202 can stop other processes using the processor 906 and dedicate the processor 906 to data collection.

Additionally, an opportunistic data transmitter 204 can evaluate broadcast and/or multicast data obtained via receiver 902. Opportunistic data transmitter 204 can employ operating parameters specified by data collector 202. The aggregated data can thereafter be transmitted to a remote location for further evaluation. Mobile device 104 still further comprises a modulator 910 and a transmitter 912 that transmits the signal to, for instance, a base station, another mobile device, a NOC (Network Operations Center), a remote agent, etc. By way of illustration and not limitation, opportunistic data transmitter 204 can use transmitter 912 in conjunction with its own transmissions. Although depicted as being separate from the processor 906, it is to be appreciated that data collector 202, opportunistic data transmitter 204 and/or modulator 910 can be part of processor 906 or a number of processors (not shown).

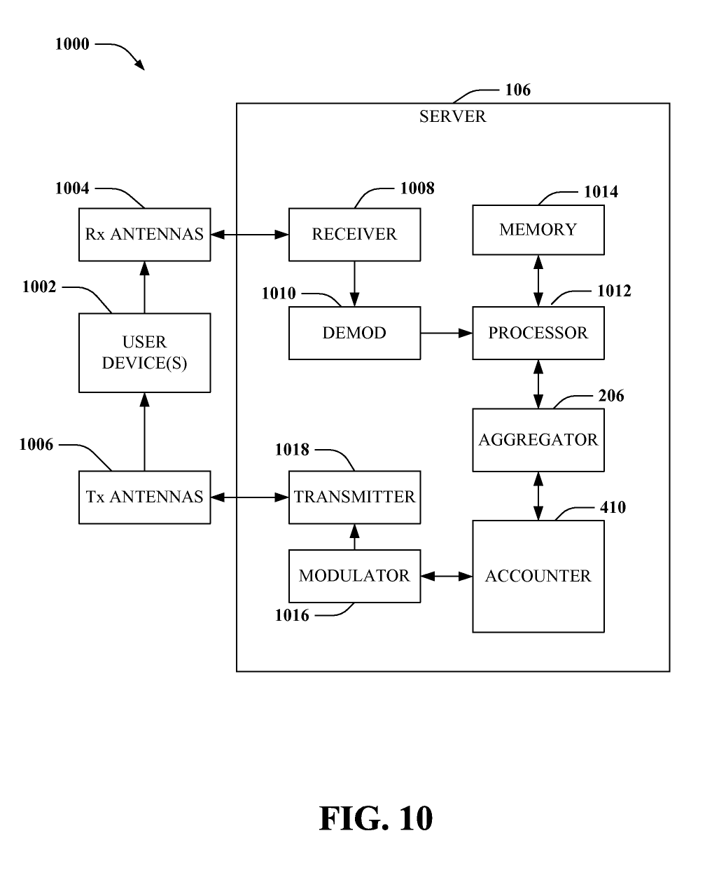

FIG. 10 is an illustration of a system 1000 that facilitates collected data reception and processing. System 1000 comprises a server 106 (e.g., base station, NOC, . . . ) with a receiver 1008 that receives signal(s) from one or more user devices 1002 through a plurality of receive antennas 1004, and a transmitter 1018 that transmits to the one or more user devices 1002 through a transmit antenna 1006. Receiver 1008 can receive information from receive antennas 1006 and is operatively associated with a demodulator (DEMOD) 1010 that demodulates received information. Demodulated symbols are analyzed by a processor 1013 that can be similar to the processor described above with regard to FIG. 9, which is coupled to a memory 1014 that stores information related to estimating a signal (e.g., pilot) strength and/or interference strength, data to be transmitted to or received from user device(s) 1002 (or a disparate server (not shown)), and/or any other suitable information related to performing the various actions and functions set forth herein. Processor 1012 is further coupled to an aggregator 206 that collects data transmitted by a mobile device 104 of FIG. 9. Aggregator 206 can use the receiver 1008 to collect data from a mobile device 104 of FIG. 9. Moreover, the aggregator 206 can store collected data in memory 1014.

Aggregator 206 can further coupled to an accounter 410 that can make financial calculations and executions based on collected data. For example, based on data collected by the aggregator 206, accounter 410 can credit an account of a user of the mobile device 104 of FIG. 9 (e.g., if a user fills out a survey, then they receive a predetermined amount of money). Collected information can be transferred from an accounter 410 to a modulator 1016. Modulator 1016 can multiplex the control information for transmission by a transmitter 1018 through antenna 1006 to the broadcast media device (e.g., user device 1004). Although depicted as being separate from the processor 1012, it is to he appreciated that aggregator 206, accounter 410 and/or modulator 1016 can be part of processor 1012 or a number of processors (not shown).

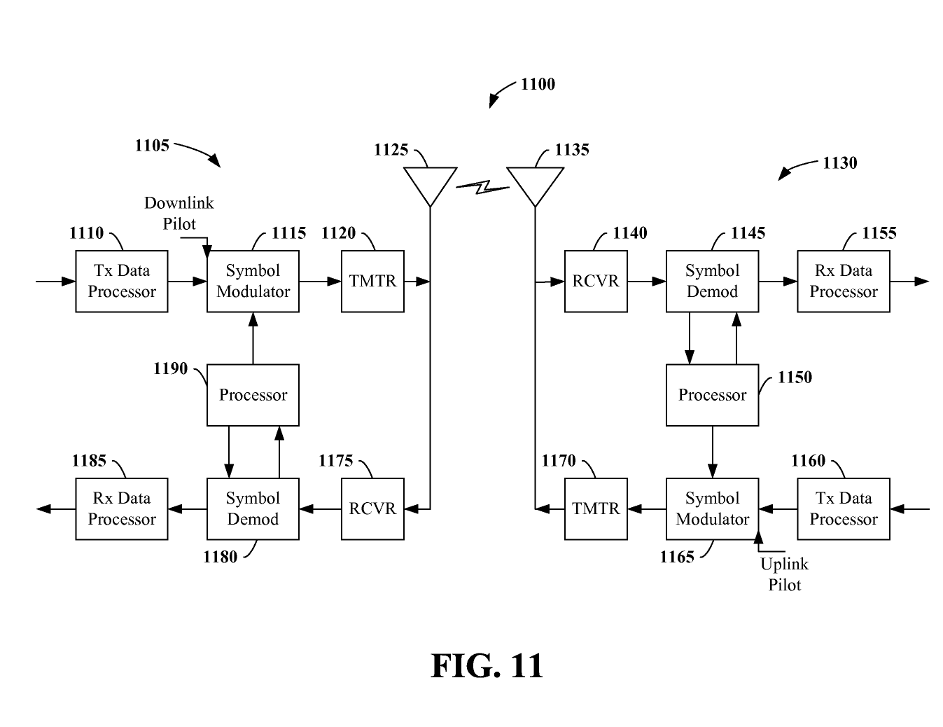

FIG. 11 shows an exemplary wireless communication system 1100. The wireless communication system 1100 depicts one access point and one terminal for sake of brevity. However, it is to be appreciated that the system can include more than one access point and/or more than one terminal, wherein additional access points and/or terminals can be substantially similar or different for the exemplary access point and terminal described below. In addition, it is to be appreciated that the access point and/or the terminal can employ the systems (FIGS. 1-5 and 9-10) and/or methods (FIGS. 6-8) described herein to facilitate wireless communication there between.

Referring now to FIG. 11, on a downlink, at access point 1105, a transmit (TX) data processor 1110 receives, formats, codes, interleaves, and modulates (or symbol maps) traffic data and provides modulation symbols (“data symbols”). A symbol modulator 1115 receives and processes the data symbols and pilot symbols and provides a stream of symbols. A symbol modulator 1115 multiplexes data and pilot symbols and provides them to a transmitter unit (TMTR) 1120. Each transmit symbol can be a data symbol, a pilot symbol, or a signal value of zero. The pilot symbols can be sent continuously in each symbol period. The pilot symbols can be frequency division multiplexed (FDM), orthogonal frequency division multiplexed (OFDM), time division multiplexed (TDM), frequency division multiplexed (FDM), or code division multiplexed (CDM).

TMTR 1120 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1125 to the terminals. At terminal 1130, an antenna 1135 receives the downlink signal and provides a received signal to a receiver unit (RCVR) 1140. Receiver unit 1140 conditions (e.g., filters, amplifies, and frequency downconverts) the received signal and digitizes the conditioned signal to obtain samples. A symbol demodulator 1145 demodulates and provides received pilot symbols to a processor 1150 for channel estimation. Symbol demodulator 1145 further receives a frequency response estimate for the downlink from processor 1150, performs data demodulation on the received data symbols to obtain data symbol estimates (which are estimates of the transmitted data symbols), and provides the data symbol estimates to an RX data processor 1155, which demodulates (e.g., symbol demaps), deinterleaves, and decodes the data symbol estimates to recover the transmitted traffic data. The processing by symbol demodulator 1145 and RX data processor 1155 is complementary to the processing by symbol modulator 1115 and TX data processor 1110, respectively, at access point 1105.

On the uplink, a TX data processor 1160 processes traffic data and provides data symbols. A symbol modulator 1165 receives and multiplexes the data symbols with pilot symbols, performs modulation, and provides a stream of symbols. A transmitter unit 1170 then receives and processes the stream of symbols to generate an uplink signal, which is transmitted by the antenna 1135 to the access point 1105.

At access point 1105, the uplink signal from terminal 1130 is received by the antenna 1125 and processed by a receiver unit 1175 to obtain samples. A symbol demodulator 1180 then processes the samples and provides received pilot symbols and data symbol estimates for the uplink. An RX data processor 1185 processes the data symbol estimates to recover the traffic data transmitted by terminal 1130. A processor 1190 performs channel estimation for each active terminal transmitting on the uplink. Multiple terminals can transmit pilot concurrently on the uplink on their respective assigned sets of pilot subbands, where the pilot subband sets can be interlaced.

Processors 1190 and 1150 direct (e.g., control, coordinate, manage, etc.) operation at access point 1105 and terminal 1130, respectively. Respective processors 1190 and 1150 can be associated with memory units (not shown) that store program codes and data. Processors 1190 and 1150 can also perform computations to derive frequency and impulse response estimates for the uplink and downlink, respectively.

For a multiple-access system (e.g., FDMA, OFDMA, CDMA, TDMA, etc.), multiple terminals can transmit concurrently on the uplink. For such a system, the pilot subbands can be shared among different terminals. The channel estimation techniques can be used in cases where the pilot subbands for each terminal span the entire operating band (possibly except for the band edges). Such a pilot subband structure would be desirable to obtain frequency diversity for each terminal. The techniques described herein can be implemented by various means. For example, these techniques can be implemented in hardware, software, or a combination thereof. For a hardware implementation, the processing units used for channel estimation can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the techniques described herein can be implemented with modules (e.g., procedures, functions, and so on) that perform the functions described herein. The software codes can be stored in memory units and executed by processors 1190 and 1150. The memory unit can be implemented within the processor or external to the processor, in which case it can be communicatively coupled to the processor via various means as is known in the art.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

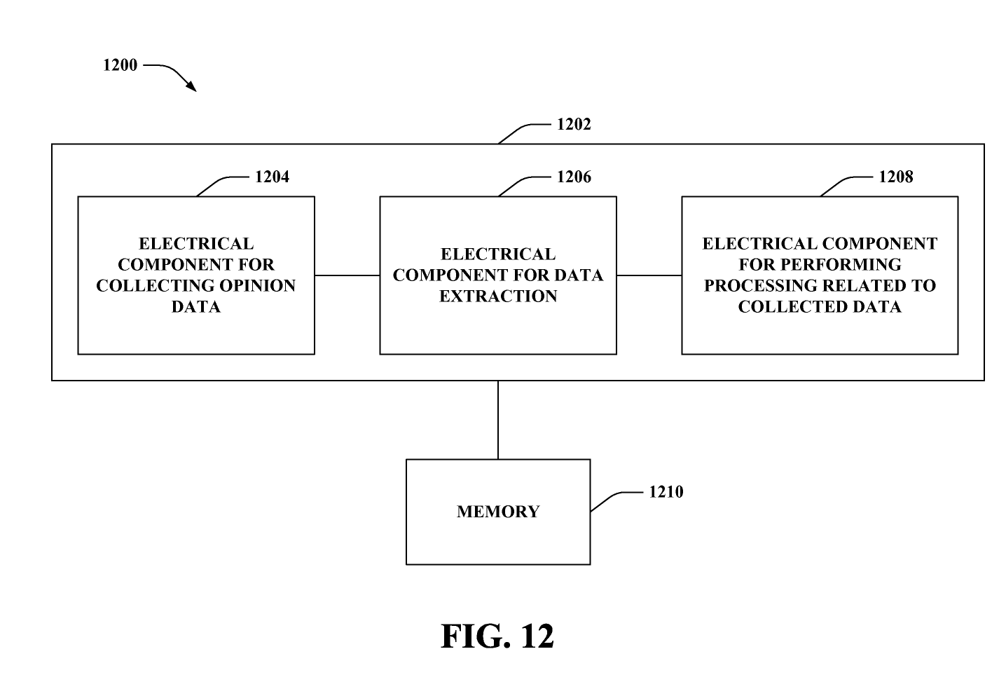

With reference to FIG. 12, illustrated is a system 1200 that collects, communicates, and processes data though an interaction. It is to be appreciated that system 1200 is represented as including functional blocks, which can be functional blocks that represent functions implemented by a processor, software, or combination thereof (e.g., firmware). System 1200 can be implemented in at least one wireless device and can include a communication device 1202. The communication device 1202 can include means for transmitting the opinion information to an auxiliary location at an opportunistic time and means for receiving a data transmission with opinion information from a mobile device, such as the mobile device 104 of FIG. 1 at an opportunistic time. Further, system 1200 can include an electrical component for collecting opinion data 1204 (e.g., means for obtaining opinion information of an operator through utilization of a mobile device application) and an electrical component for data extraction 1206 (e.g. means for extracting opinion information from the data transmission). The system 1200 can include an electrical component for performing processing related to collected data 1208 (e.g., processing the collected data, performing actions related to data collection, etc.) and memory 1210. While shown in one device, means for communicating collected data can also be part of two or more devices. For example, one part can be a means for receiving and one part can be a means for sending. Moreover, system 1200 can include means for processing collected data 1208.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates collection of opinion information, comprising:
obtaining operator opinion information through utilization of a mobile device application, obtainment of opinion information is facilitated through use of a form; and
transmitting the opinion information to an auxiliary location at an opportunistic time.

2. The method of claim 1, the opportunistic time is a time when at least one other transmission is taking place.

3. The method of claim 1, the opportunistic time is off-peak time.

4. The method of claim 1, further comprising storing at least part of the opinion information.

5. The method of claim 4, storing the opinion information takes place upon a mobile device operating the mobile device application.

6. The method of claim 4, storing the opinion information takes place upon the auxiliary location.

7. The method of claim 1, further comprising selecting the opportunistic time to transmit the opinion information, transmitting the opinion information to an auxiliary location takes place at the selected opportunistic time.

8. The method of claim 1, further comprising presenting the operator with a user interface that facilitates opinion information obtainment.

9. The method of claim 1, further comprising authenticating a request to obtain opinion information, obtaining opinion information takes place when a request is authenticated.

10. The method of claim 1, further comprising performing a financial operation based upon obtaining opinion information of an operator.

11. A wireless communication apparatus, comprising:
a data collector that obtains operator opinion information, obtainment of opinion information is facilitated through use of a form; and
a data transmitter that emits the obtained operator opinion information to an auxiliary location at an opportunistic time.

12. The apparatus of claim 11, the opportunistic time is a time when at least one other transmission is taking place.

13. The apparatus of claim 11, the opportunistic time is off-peak time.

14. The apparatus of claim 11, further comprising an accounter that performs a financial function in accordance with data obtainment or data emission.

15. The apparatus of claim 11, further comprising an initializer that enables the data collector to obtain operator opinion information.

16. The apparatus of claim 11, further comprising a form selector that selects an interface to present to an operator, the data collector obtains operator opinion information through presentment of the interface.

17. The apparatus of claim 11, further comprising a verifier that checks validity of operation of the data collector or data transmitter.

18. The apparatus of claim 11, further comprising storage that retains the obtained operator opinion information.

19. The apparatus of claim 11, further comprising an authenticator that determines if the data collector should commence operation, the data collector obtains operator opinion information upon successful determination.

20. A wireless communications apparatus that facilitates opinion information collection, comprising:
means for obtaining operator opinion information through utilization of a mobile device application, obtainment of opinion information is facilitated through use of a form; and
means for transmitting the opinion information to an auxiliary location at an opportunistic time.

21. The apparatus of claim 20, the opportunistic time is a time when at least one other transmission is taking place.

22. The apparatus of claim 20, the opportunistic time is off-peak time.

23. The apparatus of claim 20, further comprising means for storing at least part of the opinion information.

24. The apparatus of claim 20, further comprising means for selecting the opportunistic time to transmit the opinion information.

25. The apparatus of claim 20, further comprising means for presenting the operator with a user interface that facilitates opinion information obtainment.

26. The apparatus of claim 20, further comprising means for authenticating a request to obtain opinion information, obtaining opinion information takes place when a request is authenticated.

27. The apparatus of claim 20, further comprising means for performing a financial operation based upon obtaining opinion information of an operator.

28. A machine-readable medium having stored thereon machine-executable instructions for:
obtaining operator opinion information through utilization of a mobile device application, obtainment of opinion information is facilitated through use of a form; and
transmitting the opinion information to an auxiliary location at an opportunistic time.

29. The machine-readable medium of claim 28, the opportunistic time is a time when at least one other transmission is taking place.

30. The machine-readable medium of claim 28, the opportunistic time is off-peak time.

31. The machine-readable medium of claim 28, further comprising instructions for storing at least part of the opinion information.

32. The machine-readable medium of claim 28, further comprising instructions for selecting the opportunistic time to transmit the opinion information.

33. The machine-readable medium of claim 28, further comprising presenting the operator with a user interface that facilitates opinion information obtainment.

34. The machine-readable medium of claim 28, further comprising authenticating a request to obtain opinion information, obtaining opinion information takes place when a request is authenticated.

35. The machine-readable medium of claim 28, further comprising performing a financial operation based upon obtaining opinion information of an operator.

36. In a wireless communication system, an apparatus comprising:
a processor configured to:
obtain opinion information of an operator through utilization of a mobile device application, obtainment of opinion information is facilitated through use of a form; and
transmit the opinion information to an auxiliary location at an opportunistic time.

37. The method of claim 36, the opportunistic time is a time when at least one other transmission is taking place.

38. The method of claim 36, the opportunistic time is off-peak time.

39. A method that facilitates collection of opinion information, comprising:
receiving a data transmission with opinion information from a mobile device at an opportunistic time; and
rewarding an entity that provided the opinion information based upon successful receipt of the opinion information.

40. The method of claim 39, the opportunistic time is a time when at least one other transmission is taking place.

41. The method of claim 39, further comprising extracting opinion information from the data transmission

42. The method of claim 41, further comprising storing the extracted opinion information.

43. The method of claim 41, further comprising aggregating the extracted opinion information with other opinion information.

44. The method of claim 39, further comprising transmitting a form to the mobile device, the form is utilized to gather the opinion information included in the data transmission.

45. The method of claim 44, further comprising choosing the form that is transmitted to the mobile device.

46. The method of claim 39, further comprising requesting that the mobile device send a data transmission with opinion information.

47. The method of claim 46, further comprising determining if a party inquiring about an opinion has authority to request a data transmission, requesting that the mobile device send a data transmission with opinion information occurs upon a determination that the party has authority to request a data transmission.

48. The method of claim 39, further comprising authenticating at least part of the data transmission.

49. The method of claim 39, the opportunistic time is off-peak time.

50. A wireless communication apparatus, comprising:
a memory that retains instructions related to reception of a data transmission with opinion information from a mobile device at an opportunistic time and providing a reward to an entity that provided the opinion information based upon successful receipt of the opinion information; and
a processor coupled to the memory, configured to execute the instructions retained in the memory.

51. The apparatus of claim 50, the memory stores the opinion information.

52. The apparatus of claim 50, the opportunistic time is a time when at least one other transmission is taking place.

53. The apparatus of claim 50, the opportunistic time is off-peak time.

54. A wireless communications apparatus that facilitates opinion information collection, comprising:
means for receiving a data transmission with opinion information from a mobile device at an opportunistic time; and
means for rewarding an entity that provided the opinion information based upon successful receipt of the opinion information.

55. The apparatus of claim 54, further comprising means for extracting opinion information from the data transmission.

56. The apparatus of claim 55, further comprising means for storing the extracted opinion information.

57. The apparatus of claim 55, further comprising means for aggregating the extracted opinion information with other opinion information.

58. The apparatus of claim 54, the opportunistic time is off-peak time.

59. The apparatus of claim 54, further comprising means for transmitting a form to the mobile device, the form is used to gather the opinion information included in the data transmission.

60. The apparatus of claim 59, further comprising means choosing the form that is transmitted to the mobile device.

61. The apparatus of claim 54, further comprising means for requesting that the mobile device send a data transmission with opinion information.

62. The apparatus of claim 61, further comprising means for determining if a party inquiring about an opinion has authority to request a data transmission, requesting that the mobile device send a data transmission with opinion information occurs upon a determination that the party has authority to request a data transmission.

63. The apparatus of claim 54, further comprising means for authenticating at least part of the data transmission.

64. The apparatus of claim 54, the opportunistic time is a time when at least one other transmission is taking place.

65. A machine-readable medium having stored thereon machine-executable instructions for:
receiving a data transmission with opinion information from a mobile device at an opportunistic time; and
rewarding an entity that provided the opinion information based upon successful receipt of the opinion information.

66. The medium of claim 65, further comprising instructions for extracting opinion information from the data transmission.

67. The medium of claim 66, further comprising instructions for storing the extracted opinion information.

68. The medium of claim 66, further comprising instructions for aggregating the extracted opinion information with other opinion information.

69. The medium of claim 65, the opportunistic time is a time when at least one other transmission is taking place.

70. The medium of claim 65, further comprising instructions for transmitting a form to the mobile device, the form is utilized to gather the opinion information included in the data transmission.

71. The medium of claim 70, further comprising instructions for choosing the form that is transmitted to the mobile device.

72. The medium of claim 65, further comprising instructions for requesting that the mobile device send a data transmission with opinion information.

73. The medium of claim 72, further comprising instructions for determining if a party inquiring about an opinion has authority to request a data transmission, requesting that the mobile device send a data transmission with opinion information occurs upon a determination that the party has authority to request a data transmission.

74. The medium of claim 65, further comprising instructions for authenticating at least part of the data transmission.

75. The medium of claim 65, the opportunistic time is off-peak time.

76. In a wireless communication system, an apparatus comprising:
a processor configured to:
receive a data transmission with opinion information from a mobile device at an opportunistic time; and
reward an entity that provided the opinion information based upon successful receipt of the opinion information.
